(19) United States
(12) Patent Application Publication
(10) Pub. No.: US 2012/0217005 A1
(43) Pub. Date: Aug. 30, 2012

(54) METHOD AND APPARATUS FOR REDUCING LINER SLOT PLUGGING TENDENCIES

(76) Inventors: Subodh Gupta, Calgary (CA); Arnoud Struyk, Calgary (CA); Denis Gilbert, Airdrie (CA); Simon D. Gittins, Bragg Creek (CA)

(21) Appl. No.: 13/249,770

(22) Filed: Sep. 30, 2011

Related U.S. Application Data
(60) Provisional application No. 61/388,099, filed on Sep. 30, 2010.

(51) Int. Cl. E03B 3/18; B26D 3/00

(52) U.S. Cl. 166/227; 83/54

(57) ABSTRACT

A slotted liner having straight-cut liner slots with a wall roughness which does not exceed 1 μm. A slot cutting method to produce smooth slots using a specified blade configuration, rotational speed, and feed rate.

### CROSS REFERENCE TO RELATED APPLICATIONS

This application claims the benefit of and priority from U.S. Provisional Patent Application No. 61/388,099 filed Sep. 30, 2010, which is incorporated herein by reference in its entirety.

### FIELD

The present disclosure relates generally to oil production. More particularly, the present disclosure relates to slotted liner and the cutting of slots for slotted liner for heavy oil production.

### BACKGROUND

One of the key downhole devices for preventing or reducing the entry of unwanted solids into the interior of a wellbore is the slotted liner. Typically, in the petroleum industry, this is a steel pipe into which slots have been cut or machined entirely through the steel pipe wall, the slots being of a particular geometry and set of dimensions and being distributed along the pipe according to a prescribed pattern.

The traditional liner slot involves a geometry whereby the width of the slot remains constant throughout the depth of the slot (i.e., from exterior to interior surface of the pipe). The advantage of this “straight-cut” liner slot geometry is that its manufacture requires only a single pass of a rotating cutting blade.

In the petroleum industry, conventional methods of machining slots in slotted liners employ the use of standard high speed steel tooth-bearing cutting blades, producing a slot surface with a relatively rough finish, for example having a Ra of 4-8 μm or 4-6 μm. Slotted liners with conventionally machined slots, and associated Ra values, tend to plug over time as a consequence of this roughness so that the total available inflow area is reduced along with the overall productivity of the well.

To compensate for this slot plugging tendency over time, and the corresponding reduction in inflow area, conventional slotted liners are machined such that they possess an excess number of slots. The excess number of slots adds to the overall cost of producing slotted liners weakens the liners, while not necessarily extending their efficient life span.

One slotted liner manufacturer's website indicates that, for example, the area of a slotted liner occupied by slots, the open area, may be in the order of 3%. The number of slots required (per foot of length) may be calculated from the formula below:

N=12πDC/100WL

Where D is the OD of the liner, in inches. C is the selected open area, in percent. W is the selected slot width, in inches, and L is the slot length, in inches.

Thus, for a 3% open area in a 4.5″ OD liner, utilizing 0.020″ wide slots 1.5″ long, 170 slots would be required per foot (172 rounding to the next higher multiple of four as it is customary to provide 4 rows of slots per foot).

Conventional slotted liners require back flushing and acid cleaning in an effort to open up plugged slots, a method that may or may not be successful. Where these remedial techniques are not effective in restoring slot transmissivity, it may be necessary to abandon the well or re-drill the well and install a new slotted liner system.

A discussion of the slot plugging problem is presented in U.S. Patent Publication No. 2009/0014174 titled “Use of Coated Slots For Control Of Sand Or Other Solids In Wells Completed For Production Of Fluids”, Inventor E. Douglas Hollies, filed Dec. 28, 2007. Under “Summary Of Invention”, Paragraph 21, it states:

“Our investigations have revealed that slot plugging occurs when the flour-like fines that are resident within the sand reservoir pore spaces move into the slot, adhere to the slot wall, and eventually back up into the sand bridge at the entry to the slot. This adherence of fines to the slot wall is caused or facilitated by the uneven surface of the wall, whose irregular features we refer to as striations, resulting from, among other things, the blade cutting of the slots described earlier.”

Thus, the experimental investigations carried out by Hollies clearly support the conclusion that wall roughness is a major factor in slot plugging.

The solution to the slot wall roughness problem proposed by Hollies involves application of a coating to the slot walls so as to cover the uneven wall surface to provide for smooth wall surfaces. This approach entails additional cost associated with purchasing and application of the coating material.

A well-known industry approach aimed at circumventing the plugging problem involves the use of keystone slots, or of geometries which approximate the principal feature of a keystone slot.

A keystone slot has a smaller width on the upstream side (i.e., outside surface in the case of a producing well) of the pipe than on the downstream side (i.e., inside surface in the case of a producing well) of the pipe. The intent is that a solid particle, once having passed through the entry of the slot, which is its narrowest point, is thereafter unlikely to become lodged in the slot where it can aid and abet plugging. However, a disadvantage of the keystone slot is that its manufacture requires two passes of the cutting blades, each at a different angle, to achieve the variable-width slot cross-section. This creates difficulties in maintaining slot widths within acceptable tolerances.

An alternative to the keystone slot which is nonetheless aimed at achieving the advantage of a narrower entry combined with a wider exit is described in a number of patents. These include U.S. Pat. No. 6,112,570 issued Sep. 5, 2000 and titled “Method For Making Slots In Metal Pipe”, Canadian Patent No. 2,183,032 issued Jul. 17, 2001 and titled “Method For Making Slots In Metal Pipe”, and Canadian Patent No. 2,324,730 issued Aug. 12, 2003 and titled “Method And Apparatus For Reducing Slot Width in Slotted Tubular Liners”. These methods begin with a straight cut slot and then narrow the aperture of the slot entry by means of force exerted on the longitudinal edge of the slot or on the outer surface of the pipe in the vicinity of the slot so as to re-shape the slot and specifically to narrow its width at the exterior surface. A further such alternative is described in U.S. Pat. No. 7,069,657 issued Jul. 4, 2006 and titled “Method To Reduce The Width Of A Slot In A Pipe Or Tube” which subjects the metal surface to impingement or bombardment by balls, thereby achieving the narrowing of slot width while avoiding some of the machining alignment and the coordination problems associated with the prior methods cited above. Thus, while the geometric advantage of a keystone slot can be approximated using techniques that deform (i.e., narrow) the exterior (upstream) slot width, they too involve their own set of manufacturing problems.

An additional invention dealing with variable width slots is described in U.S. Pat. No. 5,046,892 issued Sep. 10, 1991 and titled “Apertured Pipe Segment”. However, this patent is concerned with plastics and with a manufacturing technique which is specific to plastics and is not applicable to the operating environment of steel slotted liners in the petroleum industry.

### SUMMARY

It is an object of the present disclosure to obviate or mitigate at least one disadvantage of previous methods and apparatus for reducing liner slot plugging tendencies.

The present disclosure, hereinafter referred to as the Subject Disclosure, relates to the prescription of a maximum level of slot wall roughness (Ra), and associated geometry, that affords a more favorable environment for flow through the slot, along a manufacturing method by which these prescribed conditions can be achieved practically. In this document. Ra refers to the roughness of the long walls of the slot.

The Subject Disclosure is based firstly on a finding, through experimental investigations, that a significant reduction in flow regime instability, and consequent liner slot plugging tendency, can be achieved by using a slotted liner having straight-cut slots in which Ra is reduced to 2 μm or lower. The Subject Disclosure is based secondly on our identification of an efficient and economic means of achieving this reduced Ra through machining techniques which entail neither the addition of a smooth coating on the slot wall, nor the multiple-pass procedure required in creating a keystone slot, nor the application of special techniques, as described above, to narrow the slot entrance and thereby approximate the effect of a keystone slot.

The Subject Disclosure, in the first instance, utilizes the finding that straight-cut slots with a Ra of less than 2 μm will permit significantly less sand production than slots with greater Ra. The Subject Disclosure also includes a method of manufacturing such slots.

In fact, while the Ra maximum criterion, as determined from experimental results described above, is 2 μm, an embodiment of the Subject Disclosure a slot manufacturing technique for manufacturing slotted liners with an Ra of 1 μm.

A further embodiment of the Subject Disclosure is an uncoated straight-cut liner slot wherein Ra does not exceed 2 μm, and which can be manufactured with an Ra of 1 μm, and a manufacturing means by which this is achieved.

A means by which this slot geometry and smoothness is achieved involves machining of the slots using special cutting means, such as, for example, a circular cutting blade of specified metallurgy with a specified range of cutting tooth size, a specified range of blade speed and a specified range of feed rates.

Thus the Subject Disclosure dictates a maximum Ra and creates a slot with a Ra value that does not exceed the maximum Ra so as to avoid or mitigate the solids plugging problem. This mitigating result is achieved while retaining the manufacturing simplicity and finer tolerances attainable with a straight-cut slot, avoids the added manufacturing cost and weakness of having a high open area, avoids the added manufacturing cost and tolerance problems associated with a keystone slot, avoids the alignment and coordination problems associated with narrowing the slot cross-section at its exterior, and avoids the additional cost of applying a suitable coating to achieve slot wall smoothness.

In a first aspect, the present disclosure provides a process for mechanically creating a slot in and through a metal material in such a way as to ensure that the maximum roughness of the two long sides of the slot wall thus created, hereinafter referred to as the wall roughness, is 2 μm (micrometers), the process including employing a hard-surface circular cutting blade with a sufficient number of teeth to permit the creation of a slot wall, the roughness of whose long sides do not exceed 2 μm, but with the number of cutting blade teeth limited so as to avoid tooth failure due to elevated stresses in the blade periphery between teeth, operating the circular blade at a rate of 165 to 1600 RPM, maintaining the feed rate in the range of 0.25 to 0.7 inches per minute, and using a circular cutting blade with the number of teeth ranging between 72 and 160.

In an embodiment disclosed, the circular cutting blade has 72 teeth on its periphery. In an embodiment disclosed, the circular blade is operated at a rate of, or approximately, 1600 rpm.

In an embodiment disclosed, the feed rate is at or approximately 0.5 inches per minute.

In an embodiment disclosed, the slots are cut through the wall of a metal pipe, for example an Oil Country Tubular Good (OCTG), such as casing or liner for mechanical completion of an oil well.

In an embodiment disclosed, the wall roughness of the slot is less than or equal to 1 μm.

In a further aspect, the present disclosure provides a method of cutting a plurality of slots into a tubular member, each slot having two long sides with a maximum roughness of substantially 2 μm, the method including providing a circular blade having between about 72 and about 160 teeth, operating the circular blade at a rate of between about 165 and about 1600 RPM, and feeding the tubular into the blade at a feed rate of between about 0.25 and about 0.7 inches per minute.

In an embodiment disclosed, the slots are cut with one pass of the blade.

In an embodiment disclosed, the blade has substantially 72 teeth. In an embodiment disclosed, the blade is composed of tungsten carbide. In an embodiment disclosed, the blade is composed of high speed steel.

In an embodiment disclosed, the rate is substantially 1600 RPM.

In an embodiment disclosed, the feed rate is substantially 0.5 inches per minute.

In an embodiment disclosed, the maximum roughness of the long sides is substantially 1 μm.

In an embodiment disclosed, the plurality of slots are cut to provide an open area in the tubular member of substantially 2.25%.

In an embodiment disclosed, the method further includes cooling the blade while cutting. In an embodiment disclosed, the method further includes administering cutting fluid to the blade prior to or during cutting or both. In an embodiment disclosed, the cutting fluid is ECO 7001 from Fuchs Lubricants. In an embodiment disclosed, the cutting fluid is administered by misting.

In a further aspect, the present disclosure provides a metal tubular having an exterior surface, an interior surface disposed internally relative to the exterior surface, and a plurality of slots extending between the exterior surface and the interior surface, the plurality of slots having long sides, the long sides having a maximum surface roughness of 2 μm.

In an embodiment disclosed, the maximum surface roughness of the long sides is 1 μm.

In an embodiment disclosed, the plurality of slots provide an open area of substantially 2.25 percent.

In a further aspect, the present disclosure provides a slotted liner for production of petroleum fluids from a bitumen formation, the slotted liner having an exterior surface, an interior surface disposed internally relative to the exterior surface, and a plurality of slots extending between the exterior surface and the interior surface, the plurality of slots having long sides, the long sides having a maximum surface roughness of 2 μm.

In an embodiment disclosed, the maximum surface roughness of the long sides is 1 μm.

In an embodiment disclosed, the plurality of slots provide an open area of substantially 2.25%.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a plot of sand production versus Ra for oil flow in accordance with the present disclosure;

FIG. 2 is a plot of average sand production through slot versus average slot pressure drop across slot wall roughness categories for liquid flow experiments in accordance with the present disclosure;

FIG. 3 is a plot of experimental correlatability versus roughness for flow stability in accordance with the present disclosure;

FIG. 4 is a profile view of a slot cutting blade in accordance with the present disclosure;

FIG. 5 is an end view of a slotting process of the present disclosure, for longitudinal slots;

FIG. 6 is an end view of a slotting process of the present disclosure, for transverse slots;

FIG. 7 is cross-section view of FIG. 5 along 7-7;

FIG. 8 is a detail of a slot of FIG. 7;

FIG. 9 is a cross-section view of FIG. 6 along 9-9;

FIG. 10 is a detail of a slot of FIG. 9;

FIG. 11 is a slotted liner of the present disclosure having longitudinal slots; and

FIG. 12 is a slotted liner of the present disclosure having transverse slots.

### DETAILED DESCRIPTION

Generally, the present disclosure provides a method and apparatus for reducing liner slot plugging tendencies.

In a petroleum well, when production fluid flows from the annulus through the slots of a liner into the production tubing, the slot plugging phenomena will be evidenced by an increase in the pressure drop delta-P (ΔP) across the slots (i.e. pressure differential between the annulus and the inner bore of the production tubing). A non-obstructed slot will allow free flow of particles small enough to pass through the slot.

Experimental Data

Experimental results were obtained through confidential laboratory tests. Fluid-sand flow tests were carried out using a fluid mixture of oil and water (O,W) in volume ratios that varied from 40.0 cc/hr (O,W) to 160.320 cc/hr (O,W). The fluid mixture was forced through a cylinder filled with sand, silt and clay. One end of the cylinder includes a slot being tested. The other end is connected to the fluid mixture (O,W). The fluid mixture is pumped under pressure through the cylinder sand, silt and clay, and exits through the test slot. During the test, both ΔP across slot and sand, silt and clay are recorded.

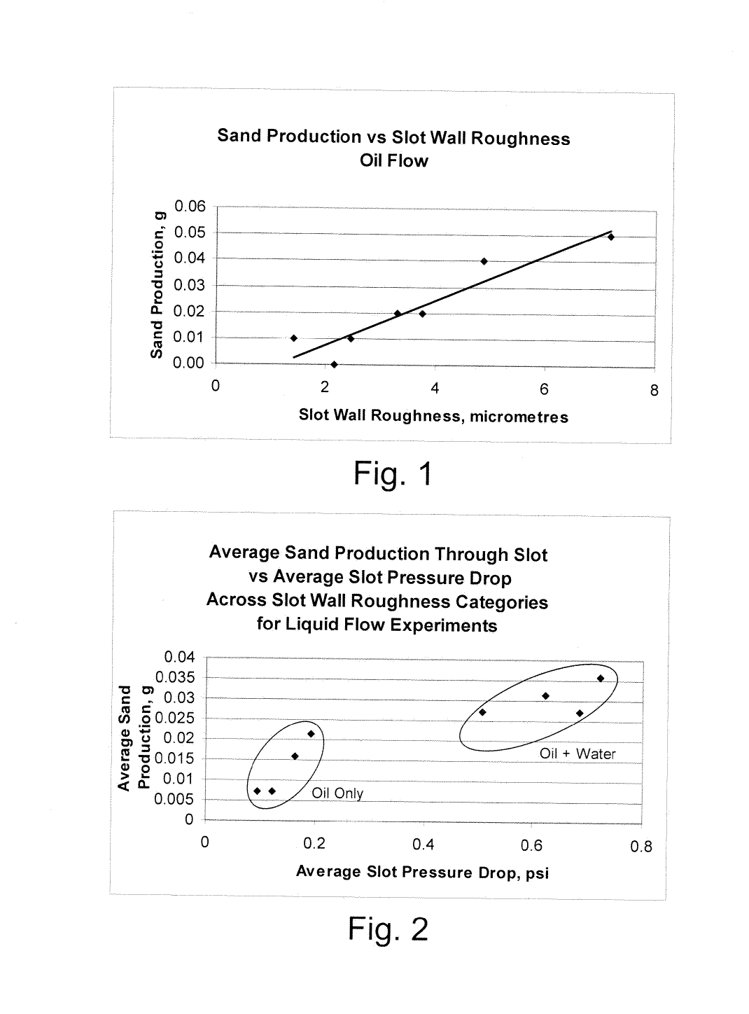

FIG. 1 is a plot of results of the fluid-sand flow tests comparing slots over a wide range of roughness values. The slots exhibit progressively higher sand production levels as slot wall roughness increases. However, the results are fairly continuous, and even generally linear, and provide no indication of a preferred maximum Ra.

FIG. 2 is a plot of average results, across all tested Ra values, illustrating the expected correlation between sand production levels and average slot pressure drop. This confirms the nature of the plugging mechanism, as described above, and provides additional verification of the reliability of the testing procedure, but otherwise offers no new insights. The data points in FIG. 2 have the following Oil (qₒ) and Water (q_{w}) flow rates per average slot pressure drop (ΔP):

| qₒ (cc/hr) | q_{w} (cc/hr) | Average ΔP (psi) |
|---|---|---|
| 40 | 0 | 0.10 |
| 80 | 0 | 0.12 |
| 120 | 0 | 0.16 |
| 160 | 0 | 0.19 |
| 160 | 80 | 0.51 |
| 160 | 160 | 0.62 |
| 160 | 240 | 0.68 |
| 160 | 320 | 0.72 |

However, in examining the correlation between sand production and pressure drop, it was noted that, as Ra increases, the flow regime exhibits a progressively higher degree of experimental variance, which is indicative of flow regime instability. As a measure of this variance characteristic, or more specifically of inverse variance, the correlations of sand production versus pressure drop were examined over a range of Ra values, and the coefficient of determination (R²) was calculated. A R² of 1.0 implies perfect correlation and a R² of zero implies a total lack of correlation.

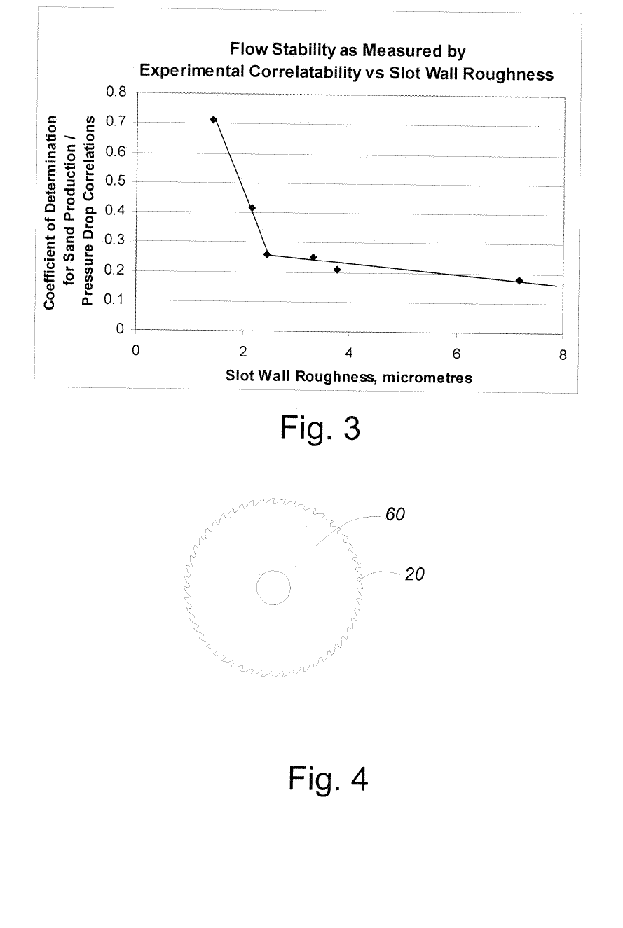

FIG. 3 is a plot of observed R² values against Ra. As indicated, there is a trend break, or substantial trend non-linearity, in the vicinity of Ra=2 μm. This suggests there is not only a quantitative difference but also a broad qualitative distinction between slots whose wall roughness values are above or below a value of some 2 μm. Specifically, over a continuous range of Ra values, the corresponding change in magnitude of the coefficient of determination is abrupt rather than continuous or gradational.

The experimental results thus establish firstly, a smooth or gradational correlation between Ra and sand production, and an abruptly changing or non-gradational correlation between Ra and flow regime stability, as indicated by the coefficient of determination. The existence the abrupt or non-gradational correlation and the specific roughness value at which this abrupt change occurs are surprising.

An embodiment of the Subject Disclosure thus applies the non-linear experimental outcome that there is material advantage in maintaining Ra at values of slots in a slotted liner at 2 μm or less.

Manufacture of Slotted Liners

An embodiment of the Subject Disclosure is an efficient means of manufacturing slotted liners having slots with an Ra<1 μm.

FIG. 4 is a blade 60 representative of one type of blade used with the present disclosure. In an embodiment, the blade 60 is made of high impact tungsten carbide. In an embodiment, the blade 60 has a number of teeth 20. In an embodiment, the teeth are profiled in a direction aligned perpendicular to the axis or rotation. In FIG. 4, the blade 60 has a number of teeth 20 directed clockwise, and in operation the blade 60 would be rotated clockwise. The number of teeth 20 in FIG. 4 number 52, which is merely one example for the number of teeth.

The blade 60 is used to produce slots with a surface finish Ra<1 μm. Conventional slot cutting methodology is improved by employing the blade having a selected number of cutting teeth at a selected RPM with a selected feed rate. Performance results indicate optimum values to select for the number of teeth, rotational speed (RPM) and feed rate. In an embodiment of the present disclosure, an Ra less than 1 μm is achieved by cutting slots with the speed of the blade 60 in the range of 165 to 1600 RPM and a typical feed rate in the range of 0.25 to 0.7 inch/minute.

The prescribed number of teeth 20 is based on running tests with cutting blades 60 with coarse teeth 20, at an intermediate level with 72 teeth 20, and on the fine end with 100 and 160 teeth 20. The diameter of the blades tested was 3″ but 4″ blades may also be used. In an embodiment disclosed, the rotational speed (RPM) selected for 3″ blades is reduced by the ratio of actual blade size. For example, 165 to 1600 RPM for 3″ diameter blades would convert to approximately 124 RPM to 1200 RPM, in order to maintain approximately the equivalent linear velocity of the teeth 20 at the circumference of the blade 60.

The lifespan of the blades 60 with teeth 20 numbering 100 and 160 teeth was limited as measured by the advent of teeth 20 that broke. The breakage of the teeth 20 occurred because the material in the root of the teeth 20 was not strong enough to withstand the force exerted on the root during the slot manufacturing process. After testing blades with 100 and 160 teeth we stepped down to 72 teeth blades to reduce the effect of stress at the root of the teeth to tolerable levels. While the number of teeth could be reduced below 72 from a stress perspective, the result would be a slot of greater Ra than that achieved using the tested configuration. Generally, the fewer teeth present on a blade, the greater the resulting Ra of slots cut by the blade. Correspondingly, it may be feasible to employ a moderate increase in the number of teeth above 72 while avoiding the above-noted problem with stress raising and structural weakness.

In an embodiment disclosed, the desired ultimate surface finish in the Ra range of 0.8-1 μm is achieved by means of a combination of a cutting blade rotation rate of some 1600 RPM, a blade feed rate of 0.5 inches per minute, and a cutting wheel having about 72 teeth. A special cutting fluid, such as that manufactured by Fuchs Lubricants with designation ECO 7001, applied through a mister system to provide lubrication and at the same time remove cuttings from the blade teeth, may be used to reproduce these results. The blade may also be cooled during cutting using lubrication and techniques as described above. This process will minimize the number of cuttings to be tracked around by the blade and score the opposite side of the slot. It is important to not allow cuttings to remain embedded within the roots of the teeth with consequent scoring. With respect to the cutting blade, an embodiment involves the use of tungsten carbide (Micrograin) blades. However, a less costly blade style, for example high speed steel (HSS), which may contain a cobalt additive to improve strength and increase cutting blade lifespan.

Rotation rate and feed rate have a direct effect on both finished quality of surface roughness and lifespan of the blade. The commercial RPM recommended for a tungsten carbide blade is 1150 RPM with adequate cooling. For HSS (cobalt enriched) recommended RPM is ˜500 RPM and for HSS (not cobalt enriched), recommended RPM is ˜200 RPM. Typical feed rates during testing ranged from 0.25-0.86 inches/min (0.1-0.36 mm/sec).

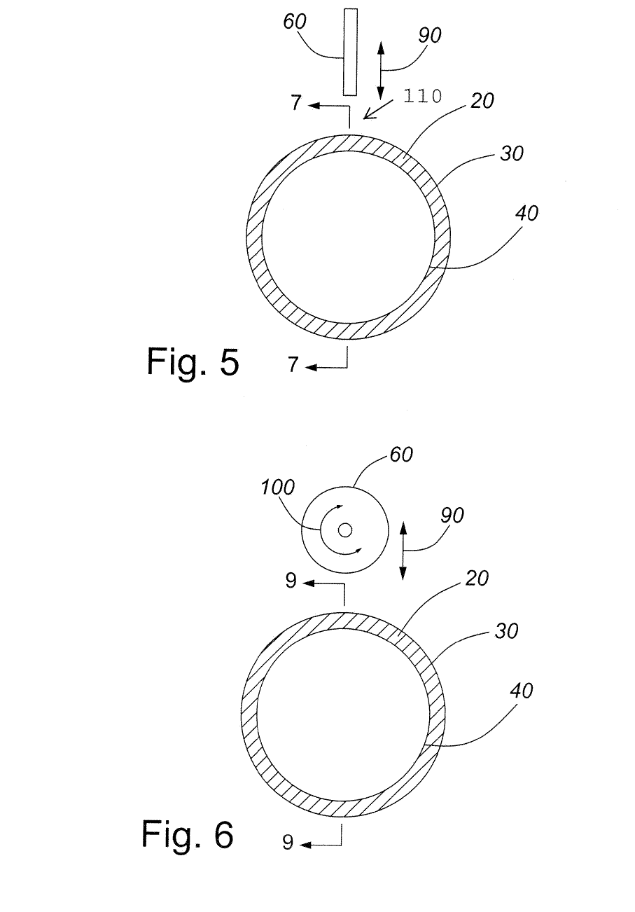

FIGS. 5, 7, and 8 depict a tubular member 20 having an exterior surface 30 and an interior surface 40. A blade 60, is aligned with the longitudinal axis of the tubular member 20 in order to cut longitudinal slots 50.

The blade 60 is rotated at a rotational speed (RPM) 100 and a feed rate 90 as indicated above is used. A cutting fluid 110 is provided to the cutting area. The resulting slot 50 has a surface finish of 0.8 to 1 μm on the long side 80.

FIGS. 6, 9, and 10 depict a tubular member 20 having an exterior surface 30 and an interior surface 40. A blade 60, is aligned perpendicular to the longitudinal axis of the tubular member 20 in order to cut transverse slots 50.

The blade 60 is rotated at a rotational speed (RPM) 100 and a feed rate 90 as indicated above is used. A cutting fluid 110 is provided to the cutting area. The resulting slot 50 has a surface finish of 0.8 to 1 μm on the long side 80.

Thus, the Subject Disclosure, as described in the above embodiments, allows use of a simpler and more efficient manufacturing method to manufacture straight-cut liner slots. The method utilizes a technique which results in slots with an Ra that does not exceed 1 μm and thereby fabricate the slotted liner with fewer slots in total, compared with standard industry practice, while maintaining the overall design inflow area.

Smooth-Slot Slotted Liners for Wellbore Completion

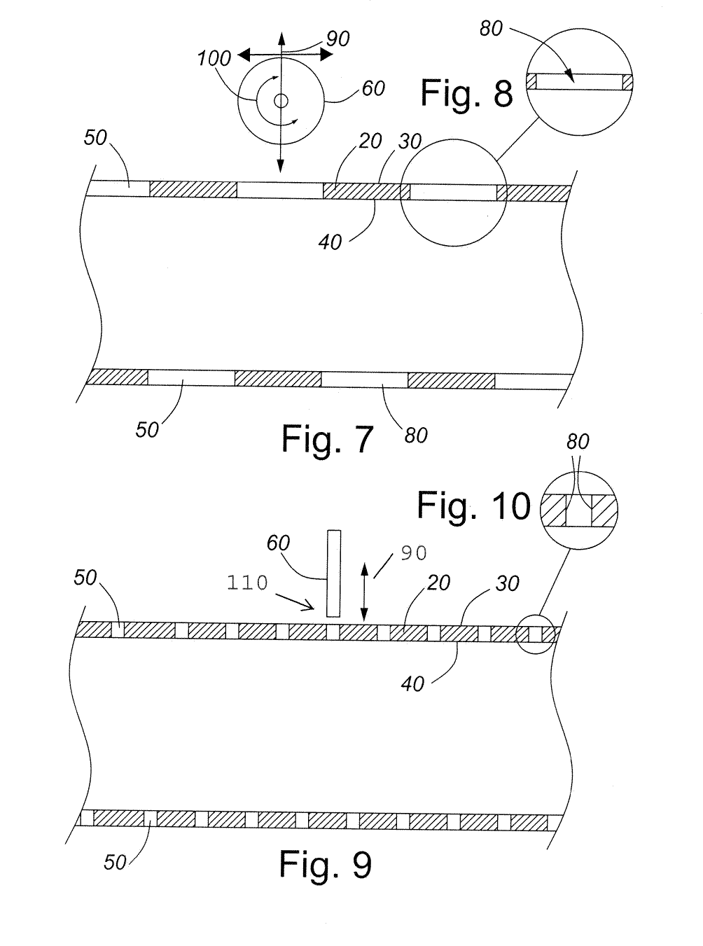

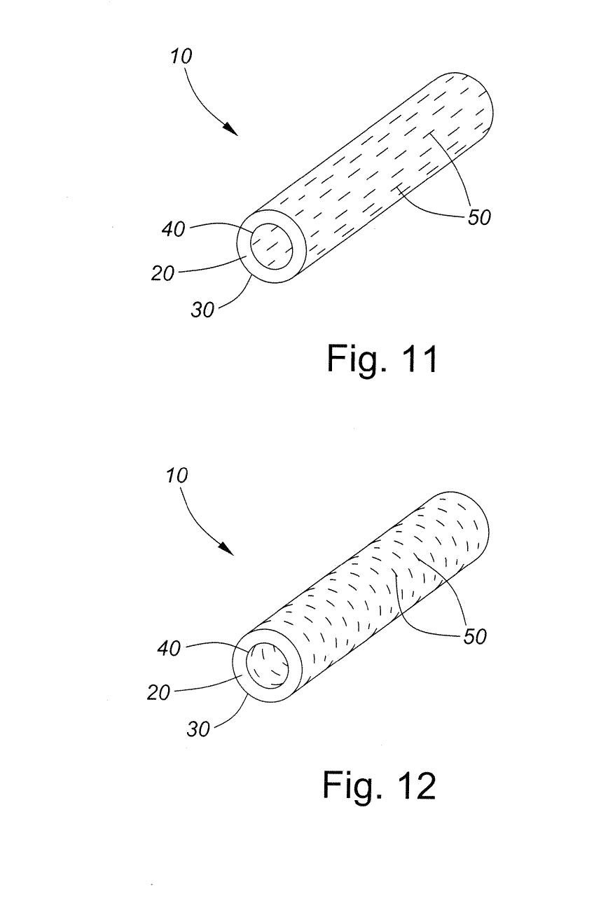

FIGS. 11 and 12 are typical slotted liners 10 of the present disclosure including a tubular member 20 having an exterior surface 30 and an interior surface 40 and a plurality of slots 50 extending there between. The slots 50 are typically longitudinal (FIG. 7) or transverse (FIG. 8) or a combination thereof (not shown). The slotted liners produced by the above techniques have an Ra of below 2 μm and in some embodiments below 1 μm. This Ra value is achieved without the use of coatings and with only one pass of a cutting blade. The smoothness of the slots reduces plugging while maintaining a lower percentage open area than would be required to maintain a selected flow rate on a slotted liner having slots with a greater Ra. A lower percentage open area provides two benefits: lowered cost of production because of fewer slots being cut, and a greater strength of a slotted liner because of the presence of fewer slots.

In an embodiment of the present disclosure, the open area may be reduced by as much as 25% while providing a hydraulically similar (pressure drop) as in standard slotted liners and lower open area resulting in a lower cost to manufacture the slots (less slot cutting) and improved mechanical strength (less wall material removed). In an embodiment of the disclosure, utilizing a 2.25% open area, 128 slots per foot would be required, down from the 172 required for 3% open area (as above) for 4.5″ OD liner with slots 0.020″ wide and 1.5″ long.

In the preceding description, the slots are described as straight-cut slots. However, the disclosure may be applied in relation to keystone-cut slots, as well as keystone-formed slots (such as those made by making straight cut slots or keystone-cuts slots and then transversely or longitudinally cold working the exterior of the slotted liner, such as by cold rolling).

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

What is claimed is:

1. A process for mechanically creating a slot in and through a metal material in such a way as to ensure that the maximum roughness of the two long sides of the slot wall thus created, hereinafter referred to as the wall roughness, is 2 μm (micrometers), the process comprising:
employing a hard-surface circular cutting blade with a sufficient number of teeth to permit the creation of a slot wall, the roughness of whose long sides do not exceed 2 μm, but with the number of cutting blade teeth limited so as to avoid tooth failure due to elevated stresses in the blade periphery between teeth;
operating the circular blade at a rate of 165 to 1600 RPM;
maintaining the feed rate in the range of 0.25 to 0.7 inches per minute; and
using a circular cutting blade with the number of teeth ranging between 72 and 160.

2. The process of claim 1 wherein the circular cutting blade has 72 teeth on its periphery.

3. The process of claim 1 wherein the circular blade is operated at a rate of, or close to, 1600 rpm.

4. The process of claim 1 wherein the feed rate is at or close to 0.5 inches per minute.

5. The process of claim 1 wherein the slots are cut through the wall of a metal pipe.

6. The process of claim 1 wherein the wall roughness of the slot is less than or equal to 1 μm.

7. A method of cutting a plurality of slots into a tubular member, each slot having two long sides with a maximum roughness of substantially 2 μm, the method comprising:
providing a circular blade having between about 72 and about 160 teeth;
operating the circular blade at a rate of between about 165 and about 1600 RPM; and
feeding the tubular into the blade at a feed rate of between about 0.25 and about 0.7 inches per minute.

8. The method of claim 7 wherein the slots are cut with one pass of the blade.

9. The method of claim 7 wherein the blade has substantially 72 teeth.

10. The method of claim 7 wherein the blade is composed of tungsten carbide.

11. The method of claim 7 wherein the blade is composed of high speed steel.

12. The method of claim 7 wherein the rote is substantially 1600 RPM.

13. The method of claim 7 wherein the feed rate is substantially 0.5 inches per minute.

14. The method of claim 7 wherein the maximum roughness of the long sides is substantially 1 μm.

15. The method of claim 7 wherein the plurality of slots are cut to provide an open area in the tubular member of substantially 2.25%.

16. The method of claim 7 further comprising cooling the blade.

17. The method of claim 7 further comprising administering cutting fluid to the blade.

18. The method of claim 17 wherein the cutting fluid is ECO 7001 from Fuchs Lubricants.

19. The method of claim 17 wherein administration of the cutting fluid is by misting.

20. A metal tubular comprising:
an exterior surface;
an interior surface disposed internally relative to the exterior surface; and
a plurality of slots extending between the exterior surface and the interior surface, the plurality of slots having long sides, the long sides having a maximum surface roughness of 2 μm.

21. The metal tubular of claim 20 wherein the maximum surface roughness of the long sides is 1 μm.

22. The metal tubular of claim 20 wherein the plurality of slots provide an open area of substantially 2.25%.

23. A slotted liner for production of petroleum fluids from a bitumen formation, the slotted liner comprising:
an exterior surface;
an interior surface disposed internally relative to the exterior surface; and
a plurality of slots extending between the exterior surface and the interior surface, the plurality of slots having long sides, the long sides having a maximum surface roughness of 2 μm.

24. The slotted liner of claim 23 wherein the maximum surface roughness of the long sides is 1 μm.

25. The slotted liner of claim 23 wherein the plurality of slots provide an open area of substantially 2.25%.
